(19) United States
(12) Patent Application Publication
(10) Pub. No.: US 2026/0277404 A1
(43) Pub. Date: Sep. 17, 2026

(54) METHOD, APPARATUS, DEVICE AND STORAGE MEDIUM FOR PLAYBACK CONTROL

(71) Applicant: Bytedance Technology Ltd., Grand Cayman (KY)

(72) Inventors: Tong Xing, Beijing (CN); Xuanru Ding, Culver City, CA (US)

(21) Appl. No.: 19/253,453

(22) Filed: Jun. 27, 2025

(30) Foreign Application Priority Data
Mar. 17, 2025 (CN) 202510314850.7

(51) Int. Cl. G06F 3/0484; G11B 27/00

(52) U.S. Cl. CPC G06F 3/0484; G11B 27/005

(57) ABSTRACT

Methods, apparatuses, devices, and storage media for playback control are provided. An example method for playback control includes: presenting a first image of a first video; triggering a progress control mode for the first video in response to detecting a first operation on a first control, wherein the first operation indicates triggering the first control continuously within a predetermined time period; and adjusting a playback progress of the first video in response to detecting at least one of the first operation or a second operation on the first control in the progress control mode, wherein the second operation indicates a click trigger for the first control.

### CROSS REFERENCE

This application claims priority to Chinese Application No. 202510314850.7, filed on Mar. 17, 2025 and entitled “METHOD, APPARATUS, DEVICE AND STORAGE MEDIUM FOR PLAYBACK CONTROL”, the entirety of which is incorporated herein by reference.

### FIELD

Example embodiments of the disclosure generally relate to the field of computers, and in particular, to a method, an apparatus, a device and a computer readable storage medium for playback control.

### BACKGROUND

With the rapid development of the Internet, video players have become indispensable components in websites and applications. The requirement of the user on the playback experience is also increasing, for example, when the user watches an audio or a video, the audio or the video usually needs to be fast-forwarded, rewound, and jumped to a certain time point. Therefore, providing a convenient and efficient way for the user to adjust the progress of a video is a key to improve the user experience.

### SUMMARY

In a first aspect of the disclosure, a method for playback control is provided. The method includes: presenting a first image of a first video; triggering a progress control mode for the first video in response to receiving a first operation on a first control, wherein the first operation indicates triggering the first control continuously within a predetermined time period; and adjusting a playback progress of the first video in response to detecting at least one of the first operation or a second operation on the first control in the progress control mode, wherein the second operation indicates a click trigger for the first control.

In a second aspect of the disclosure, an apparatus for playback control is provided. The apparatus includes: a first video presenting module configured to present a first image of a first video; a progress control mode triggering module configured to trigger a progress control mode for the first video in response to detecting a first operation on a first control, wherein the first operation indicates triggering the first control continuously within a predetermined time period; and a playback progress adjusting module configured to adjust a playback progress of the first video in response to detecting at least one of the first operation or the second operation on the first control, wherein the second operation indicates a click trigger for the first control.

In a third aspect of the disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the disclosure, a computer-readable storage medium is provided. The computer readable storage medium has computer executable instructions stored thereon, and the computer executable instructions are executable by a processor to implement the method of the first aspect.

According to a fifth aspect of the disclosure, there is provided a computer program product, including computer executable instructions, wherein the computer executable instructions, when executed by a processor, implement the method according to the first aspect.

It should be understood that the content described in this content section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure may be implemented;

FIGS. 2A to 2K are schematic diagrams of an example interface for playback control according to some embodiments of the disclosure;

FIG. 3 illustrates a flowchart of a process for playback control according to some embodiments of the disclosure;

FIG. 4 illustrates a block diagram of an apparatus for playback control according to some embodiments of the disclosure; and

FIG. 5 illustrates a block diagram of a device capable of implementing one or more embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as being limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

In the description of the embodiments of the disclosure, the terms “including” and the like should be understood as open-ended inclusion, i.e., “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

Herein, unless explicitly stated, performing one step “in response to A” does not imply that this step is performed immediately after “A”, but may include one or more intermediate steps.

It may be understood that data involved in the technical solution (including but not limited to the data itself, obtaining or usage of the data) should comply with the requirements of corresponding laws and regulations and related provisions.

It can be understood that, before the technical solutions disclosed in the embodiments of the disclosure are used, the types, the usage scope, the usage scenario and the like of personal information related to the disclosure should be notified to the user in an appropriate manner according to the relevant laws and regulations, and the authorization thereof should be obtained from the user.

For example, in response to receiving an active request from a user, prompt information is sent to the user to explicitly prompt the user that the requested operation will need to obtain and use personal information of the user, so that the user may autonomously select whether to provide personal information to software or hardware, such as an electronic device, an application, a server or a storage medium, executing the operation of the technical solution of the disclosure according to the prompt information.

As an optional but non-limiting implementation, in response to receiving an active request of the user, a manner of sending prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing processes of notification and obtaining a user authorization are merely illustrative, and do not constitute a limitation on implementations of the disclosure, and other manners of meeting related laws and regulations may also be applied to implementations of the disclosure.

As mentioned briefly above, when the user watches an audio or a video, the audio or the video may usually be advanced (e.g., fast-forwarded), reversed (e.g., fast-rewound), and jumped to a certain time point. Conventionally, for some video applications, the user may send an instruction for adjusting media content based on an upper key and a lower key, so as to directly adjust a progress of the media content. For other some video applications, the user may send an instruction for presenting a progress bar based on an upper key, a lower key, a left key, and a right key, thereby bringing out the progress bar. Further, the instruction for adjusting the media content is sent again based on the left key and the right key, thereby adjusting the progress of the media content. However, the media content cannot be played quickly in the foregoing manner, and it is required to enter a separate player for playback. Correspondingly, there is no interaction control in the process of playing the media content, and the foregoing video application is mainly applicable to media content with a relatively long duration.

Further, for still other video applications, if the user clicks an upper key or a lower key, a switching instruction for switching to the previous video or the next video is sent. If the user clicks on a left key or a right key, an instruction for favoriting, liking, commenting, or the like is sent. In this scenario, if the user clicks an upper key or a lower key, other media content is directly switched to, thereby reducing the user experience. Correspondingly, it may also fail to adjust the progress of the media content even if the user clicks a left key or a right key.

In view of this, the disclosure provides an improved solution for playback control. According to the solution of the embodiment of the disclosure, a first image of a first video is presented. If a first operation on a first control is received, a progress control mode for the first video is triggered. The first operation indicates triggering the first control continuously within a predetermined time period. Further, in response to detecting at least one of the first operation or a second operation on the first control, a playback progress of the first video is adjusted, wherein the second operation indicates a click trigger for the first control.

In this way, entering the progress control mode is triggered based on a specific operation on the control, and in this mode, the playback progress of the video may be adjusted by further operation on the control. In the progress control mode, the user focuses on adjustment for the playback progress, thereby improving the user experience.

Example embodiments of the disclosure are described below with reference to the accompanying drawings.

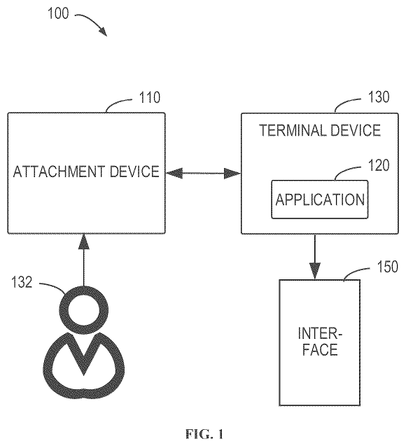

FIG. 1 illustrates a schematic diagram of an example environment 100 in which embodiments of the disclosure may be implemented. In the example environment 100, an instance of the application 120 is installed in a terminal device 130. A user 132 may interact with the application 120 via an attachment device 110 of the terminal device 130. In some embodiments, the attachment device 110 may be any type of attachment device, such as a remote control, keyboard, mouse, optical pen, handwriting input panel, speech input apparatus, or the like.

In some embodiments, the application 120 may be any suitable application that may provide progress adjustment services for the user 132. As one example, the application 120 may be an application for adjustment. As another example, the application 120 may be an instant messaging (IM) application. It should be understood that the above is merely an example of the application 120 and is not intended to be limiting, and the application 120 may be any suitable type of application that provides progress adjustment services. In the environment 100 of FIG. 1, if the application 120 is in an active state, the terminal device 130 may present an interface 150 of the application 120. The interface 150 may include various types of pages that may be provided by the application 120, such as a playing page, a browsing page, a viewing page, or the like.

In some embodiments, the terminal device 130 may communicate with a server to enable the supply of services to the application 120. The terminal device 130 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/ video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 130 may also support any type of interface for a user (such as a “wearable” circuit, etc.). The server may be various types of computing systems/servers capable of providing computing capability, including, but not limited to, a mainframe, an edge computing node, a computing device in a cloud environment, or the like.

It should be understood that the structures and functions of various elements in the environment 100 are described for illustrative purposes only and do not imply any limitation to the scope of the disclosure.

Various example implementations of the disclosure will be described in detail below with reference to the accompanying drawings. It should be understood that the pages shown in the drawings are merely examples, and various page designs may actually exist. Various graphical elements in the page may have different arrangements and different visual representations, one or more of the elements may be omitted or replaced, and one or more other elements may also be present. Embodiments of the disclosure are not limited in this regard. In addition, in the following, example embodiments will be described primarily with respect to the terminal device 130. It should be understood that acts described with respect to the terminal device 130 may be performed by the application 120 on the terminal device 130, or may be performed by the application 120 in cooperation with its server terminal (for example, the server).

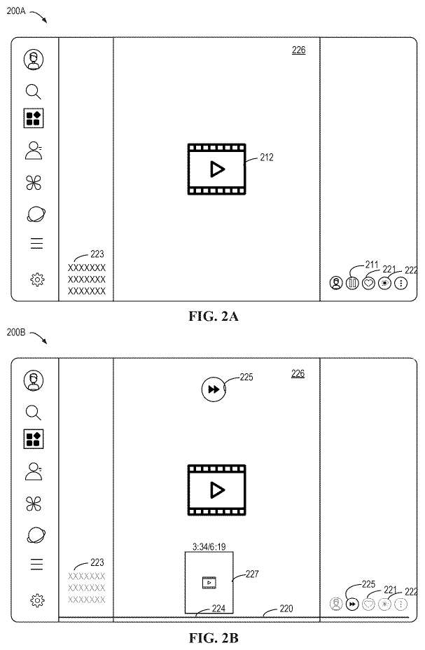

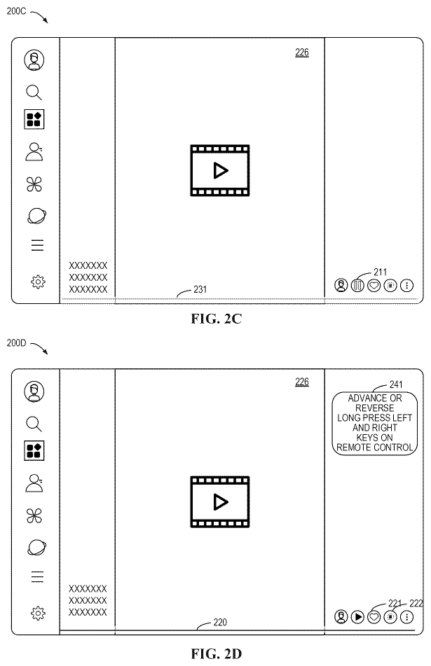

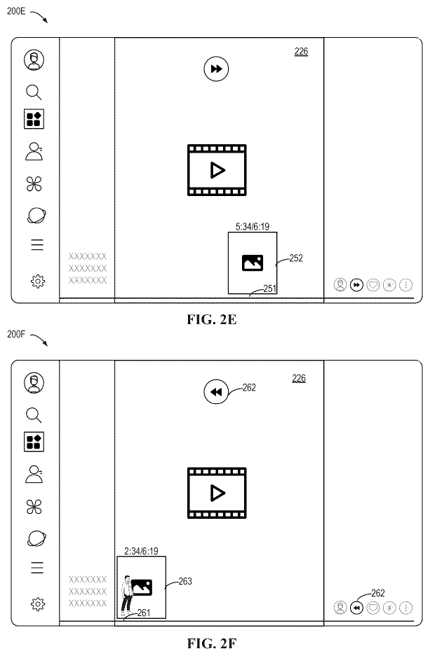

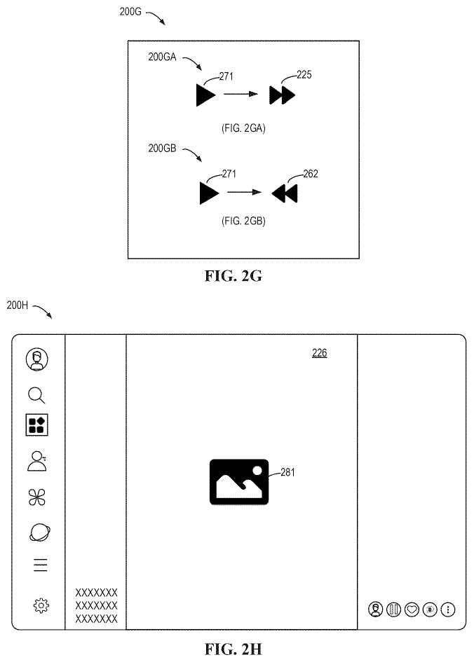

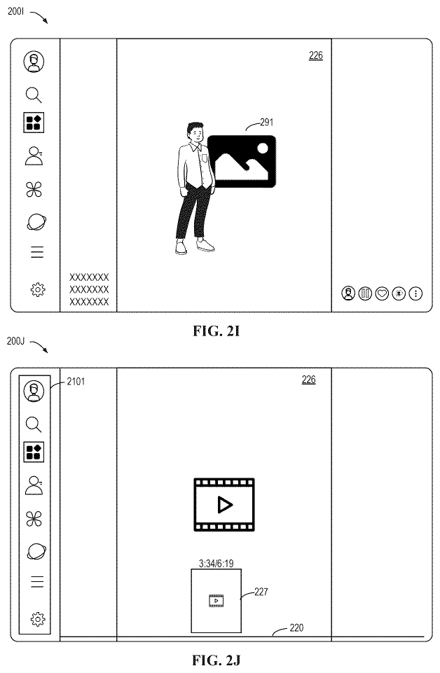

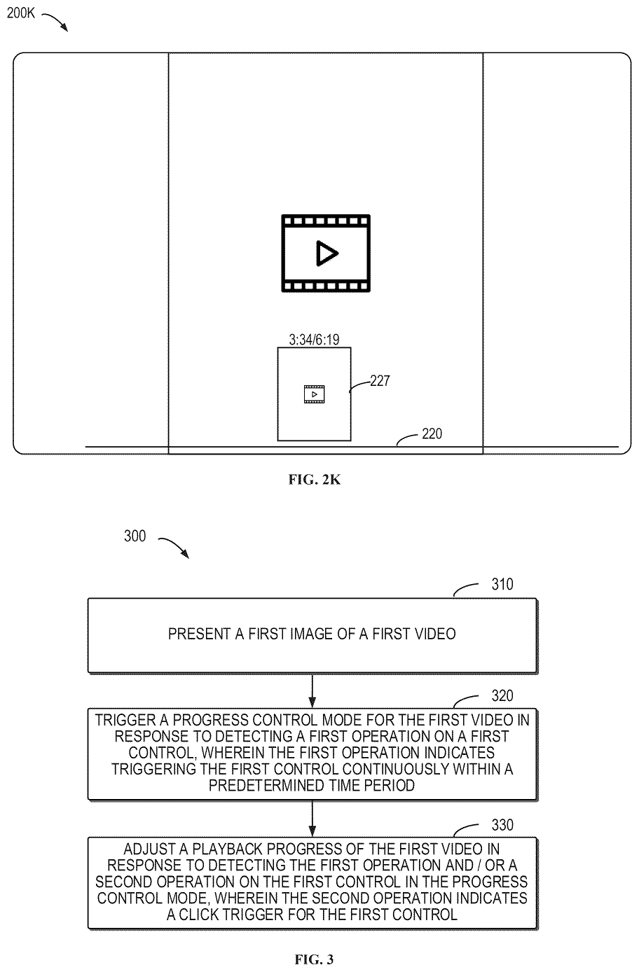

FIGS. 2A-2K illustrate schematic diagrams of example interfaces 200A-200K for playback control according to some embodiments of the disclosure.

In an embodiment of the disclosure, the terminal device 130 presents a first image of a first video. In some embodiments, the terminal device 130 may play the first video. In some embodiments, the first video may be dynamically playable content such as a dynamically played image set, a dynamic image, or the like. The first video may be provided in any suitable application or platform of the terminal device 130. In some embodiments, the user 132 may interact with the application 120 through an attachment device 110 (e.g., a remote control) of the terminal device 130. In some embodiments, the user 132 may adjust the first video by the attachment device 110 (e.g., a remote control) of the terminal device 130. For example, the user 132 may adjust the first video through a control such as an upper key, a lower key, a left key, a right key, a return key, a home key for returning to a home page, or the like of the remote control. The attachment device of the terminal device 130 may be any type of attachment device, which is not limited in the disclosure. For example, the attachment device 110 may also be various types of handles, such as a wired handle, a wireless handle, an analog handle, a joystick type handle, or the like, for implementing playback control of the video. In some scenarios, a virtual remote control may be controlled by using these handles, so as to implement the playback control of the video. The virtual remote control may be presented in a virtual display interface. For example, in a virtual reality (VR) scenario, a trigger for a control such as a right key, a left key, an upper key, a lower key, or the like of the virtual remote control may be implemented by toggling a joystick of these handles rightward, leftward, upward, downward, or the like. Correspondingly, a long-press trigger for the left key or the right key of the virtual remote control may be implemented by continuously toggling the joystick leftward or rightward.

In an embodiment of the disclosure, if detecting a first operation for a first control, the terminal device 130 triggers a progress control mode for the first video. In some embodiments, the first operation indicates triggering the first control continuously within a predetermined time period, for example, it may be a long-press operation on the first control, and thus the first operation is also referred to as a long-press trigger. In some embodiments, if it is determined that the progress control mode is triggered, the terminal device 130 may present a progress bar of the first video. As shown in the example interface 200B of FIG. 2B, in a case that the progress control mode is triggered, the terminal device 130 may present the progress bar of the first video in a user interface (such as the example interface 200B). In some embodiments, the terminal device 130 may enter the progress control mode if a trigger instruction by the user 132 for the first control is continuously detected within a predetermined time period (e.g., 0.5 seconds, or any other suitable time). Correspondingly, the progress bar of the first video is presented in the progress control mode. In some embodiments, in the progress control mode, the terminal device 130 may present the adjusted playback progress of the first video on the progress bar.

That is, the user 132 may long press the first control to enter the progress control mode. In the embodiment of the disclosure, after entering the progress control mode, the terminal device 130 adjusts the playback progress of the first video if at least one of the first operation or a second operation on the first control is detected. In the progress control mode, different operations on the first control are supported to perform adjustment of the playback progress. As previously mentioned, the first operation may include a long-press trigger. In some embodiments, the second operation indicates a click trigger for the first control, for example, it may be a short-press operation on the first control. In the progress control mode, the terminal device 130 may adjust the playback progress of the first video in a backward direction or a forward direction based on detecting at least one of the long-press trigger or the click trigger for the first control in the progress control mode. That is, in the progress control mode, the playback progress may be allowed to be adjusted by advancing or reversing (e.g., fast forwarding or rewinding). The user 132 may adjust the playback progress of the first video, e.g., by advancing or reversing, based on the first control included in the attachment device 110.

In some embodiments, the first control may include a directional control in the attachment device 110 (e.g., a remote control), such as a leftward control (i.e., a left key) and/or a rightward control (i.e., a right key). In some examples, the leftward control may indicate a backward direction, and the rightward control may indicate a forward direction. It should be understood that, in a scenario for triggering an entry of the progress control mode for the first video, the first control may further indicate any other control capable of triggering the entry of the progress control mode. As shown in the example interfaces 200A and 200B shown in FIGS. 2A and 2B, when the playback control 211 is in a selected state, the user 132 may press the left key or the right key included in the attachment device 110 to enter the progress control mode, so as to adjust the playback progress of the first video. The terminal device 130 may trigger the progress control mode for the first video if a trigger for the left key or the right key of the attachment device 110 is continuously detected within a predetermined time period (e.g., 0.5 seconds, or any other suitable time). A progress bar 220 is presented in an image 226 for presenting the first video.

In some embodiments, the terminal device 130 may present, while presenting a first image o the first video, a plurality of interface elements for triggering interaction with the first video. As shown in the example interface 200A shown in FIG. 2A, the terminal device 130 may present the first video in the first image (for example, the image 226 in the example interface 200A). Correspondingly, the terminal device 130 may further present, in an area associated with the image 226, a plurality of interface elements for triggering interaction with the first video, for example, a like control 221, a comment control 222, a description information 223, or the like.

In some embodiments, in a non-progress control mode for the first video, the first control may be used to switch an interface element associated with the first video. In this case, the first video may be in a playback state or a paused state in the non-progress control mode. That is, the progress control mode and the non-progress control mode are mainly used to distinguish whether the playback progress of the video needs to be controlled, that is, fast forwarding or rewinding control is performed on the video. In the non-progress control mode, if a second operation (for example, a click trigger) on the first control is detected, the terminal device 130 may switch from a first interface element associated with the first video to a second interface element associated with the first video. Further, in the non-progress control mode, if the first operation on the first control (for example, a long-press trigger) is detected, the terminal device 130 may activate the progress control mode for the first video. As shown in the example interface 200A shown in FIG. 2A, in the non-progress control mode for the first video, if a click trigger for the rightward control (for example, the right key) is detected, the terminal device 130 may switch from the playback control 211 to the like control 221. Correspondingly, in the non-progress control mode for the first video, if a click trigger for the leftward control (for example, the left key) is detected, the terminal device 130 may switch from the like control 221 to the playback control 211.

In some embodiments, in the progress control mode, the terminal device 130 may hide the plurality of interface elements. In some embodiments, if it is determined that the progress control mode is triggered, the terminal device 130 may hide the plurality of interface elements in the area associated with the image 226, but may continuously present the progress bar of the first video. That is, in the progress control mode, the plurality of interface elements in the interface are hidden. As shown in the example interface 200J shown in FIG. 2J, in the progress control mode, the terminal device 130 may cancel the presentation of other interface elements in the area associated with the image 226, for example, cancel the presentation of the like control 221, the comment control 222, the description information 223, or the like. The terminal device 130 only presents the first video, the progress bar 220, a thumbnail 227, and a navigation bar 2101 in the interface. As another example interface 200K shown in FIG. 2K, the terminal device 130 may present the first video, the progress bar 220, and the thumbnail 227 only in a user interface (such as the example interface 200K). By hiding other interface elements unrelated to progress control, the user may focus on the control of the playback progress.

In some embodiments, in the progress control mode, the progress bar of the first video may be presented in a particular visual style. In some examples, the terminal device 130 may more prominently present the progress bar 220, for example, with respect to the brightness and definition of the progress bar being presented in the non-progress control mode, the brightness, definition, or the like of the progress bar 220 may be increased in the progress control mode. For example, the terminal device 130 may also increase, in the progress control mode, a width of the progress bar being presented, or present the progress bar 220 in a filled visual style with respect to the width of the progress bar being presented in the non-progress control mode. In the progress control mode, the terminal device 130 may further adjust a position of the progress bar 220 being presented. For example, with respect to the position of the progress bar being presented in the non-progress control mode, the progress bar may be moved upward by a predetermined unit (e.g., closer to a center position of the user interface) in the progress control mode. However, these are merely illustrative, which is not limited in the disclosure.

In some embodiments, in the non-progress control mode for the first video, the terminal device 130 may determine, based on a total duration of the first video, whether to present the progress bar while presenting the first video. In the non-progress control mode for the first video, if it is determined that the total duration of the first video exceeds a certain duration threshold (sometimes referred to herein as a fourth duration threshold), the terminal device 130 may present the progress bar while presenting the first video (for example, playing the first video). In some examples, the terminal device 130 presents the progress bar in the first visual style while playing the first video. In other cases, in the non-progress control mode for the first video, if the total duration of the first video is less than the fourth duration threshold, the terminal device 130 may not present the progress bar while playing the first video. This is because in the case of the same display interface size, if a length of the video is short, the dynamic change amplitude of the playback progress in the progress bar in unit of time is relatively large, which may affect the attention of the user to the first video.

As shown in the example interface 200A shown in FIG. 2A, in the non-progress control mode for the first video, if it is determined that the total duration of the first video is less than the fourth duration threshold (for example, 30 seconds or any other suitable duration), the terminal device 130 may not present the progress bar 220 when playing the first video. Thus, the problem that the user is distracted due to rapid movement of the progress bar 220 can be avoided. As shown in the example interface 200C shown in FIG. 2C, in the non-progress control mode for the first video, if it is determined that the total duration of the first video is greater than the fourth duration threshold (for example, 30 seconds or any other suitable duration), the terminal device 130 may display the progress bar 220 in the first visual style 231 when playing the first video. For example, with respect to the progress bar 220 being not displayed in the user interface, the terminal device 130 may present the progress bar 220 with a lower brightness. However, this is merely illustrative, which is not limited in the disclosure, for example, a grayscale of the progress bar may also be reduced.

In some embodiments, if the terminal device 130 detects a pause control instruction for pausing the playing of the first video, it may present the progress bar in a second visual style. In some embodiments, the first visual style is different from the second visual style, i.e., the second visual style more prominently presents the progress bar 220 than the first visual style. As shown in the example interface 200D shown in FIG. 2D, if a pause playback indication for the first video is detected, the terminal device 130 may present the progress bar 220 in the second visual style in the user interface (e.g., the example interface 200D). In some examples, in a scenario in which the playing of the first video is paused, the terminal device 130 may more prominently present the progress bar 220 in the user interface (for example, the example interface 200D). For example, with respect to displaying the progress bar 220 in the first visual style, the terminal device 130 may increase brightness, definition, or the like of the progress bar 220. For example, with respect to displaying the progress bar 220 in the first visual style, the terminal device 130 may also increase a width of the progress bar being presented, or present the progress bar 220 in a filled visual style. However, these are merely illustrative, which is not limited in the disclosure.

In some embodiments, in the non-progress control mode for the first video, if a pause playback instruction for the first video is detected, the terminal device 130 may maintain presentation of the plurality of interface elements. In some embodiments, in the non-progress control mode for the first video, if the pause playback instruction for the first video is detected, the terminal device 130 may maintain the presentation of the plurality of interface elements instead of hiding the interface elements. As shown in the example interface 200D shown in FIG. 2D, if the pause playback instruction for the first video is detected, the terminal device 130 may maintain, in the user interface, presentation of the plurality of interface elements (for example, an interface element such as a like control 221, a comment control 222, or the like), so that the user 132 performs an interaction operation associated with the first video.

In some embodiments, in the non-progress control mode for the first video, if the pause playback instruction for the first video is detected, the terminal device 130 may also present guidance information related to triggering and/or exiting of the progress control mode, for example, guidance information for guiding the user to trigger the progress control mode, and/or guidance information for prompting the user to cancel the progress control mode. As shown in the example interface 200D shown in FIG. 2D, if a trigger for the pause playback control of the first video is detected, the terminal device 130 may present guidance information 241 for guiding the user to trigger the progress control mode. In some embodiments, the terminal device 130 may determine whether the guidance information is presented to the user one or more times. If the guidance information has been presented to the user one or more times, it means that the user may have learned how to trigger and/or exit the progress control mode, and thus may no longer continue to provide guidance information when the first video is paused. With the guidance information being presented, the terminal device 130 may cancel presentation of the guidance information 241 after a predetermined time period (e.g., 10 seconds or any other suitable duration).

The following describes, with reference to the accompanying drawings, how the terminal device 130 adjusts the playback progress of the first video based on the at least one of first operation or the second operation for the first control after entering the progress control mode. For ease of understanding, the playback progress of the first video is illustratively described with reference to FIG. 2B. In the example of FIG. 2B, the progress control mode of the first video has been triggered. While entering the progress control mode, the current playback progress of the first video is assumed to be from the start (0 second) of progress bar 220 to a nA position 224 of the progress bar 220. That is, the progress currently indicated by the progress bar 220 is the current playback progress of the first video.

In some embodiments, if it is determined that the progress control mode is triggered, the terminal device 130 may advance the playback progress of the first video by a first predetermined amount based on the first control including a rightward control. For example, if it is detected that the user 132 long-presses the right key, the terminal device 130 may trigger the progress control mode, and advance the playback progress of the first video by a first predetermined amount (for example, 5 seconds, 10 seconds, or any other suitable predetermined amount) to achieve the effect of simultaneously triggering the progress control mode and a single fast-advancing.

In some embodiments, if it is determined that the progress control mode is triggered, the terminal device 130 may advance the playback progress of the first video by a second predetermined amount based on the first control including a leftward control. For example, if it is detected that the user 132 long-presses the left key, the terminal device 130 may trigger the progress control mode, and reverse the playback progress of the first video by a second predetermined amount (for example, 5 seconds, 10 seconds, or any other suitable predetermined amount), so as to achieve the effect of triggering the progress control mode and a single fast-reversing simultaneously.

Assuming that the progress control mode is triggered by long-pressing the right key or the left key (i.e., the rightward or the leftward control), a single fast-advancing or fast-reversing of the playback progress may be performed first when entering the progress control mode by long-pressing the right key or the left key (e.g., for 0.5 seconds). In some embodiments, the first predetermined amount for fast advancing and the second predetermined amount for fast reversing may be the same duration, or may be different durations.

Further, in the progress control mode, the terminal device 130 may start from the playback progress after it is advanced by the first predetermined amount or reversed by the second predetermined amount, and if at least one of the first operation or the second operation on the first control is detected, the playback progress of the first video may continue to be adjusted. It may be understood that, after triggering the progress control mode and advancing the progress by the first predetermined amount or reversing the progress by the second predetermined amount, the terminal device 130 may continue to adjust the playback progress of the first video if at least one of the first operation or the second operation on the first control is detected. For example, the user 132 may long-press the left key or the right key to enter the progress control mode, and at this time, the playback progress of the first video also be reversed or advanced by 5 seconds. On this basis, the user 132 may click again or long-press the left key or the right key in the progress control mode to continue to adjust the playback progress of the first video.

In some embodiments, if the first operation on the first control is detected, the terminal device 130 adjusts the playback progress of the first video at a speed. If a continuous trigger (for example, a long-press trigger) for the rightward control (that is, the right key) is detected, the terminal device 130 may fast forward the first video at a speed. If a continuous trigger (for example, a long-press trigger) for the leftward control (that is, the left key) is detected, the terminal device 130 may fast rewind the first video at a speed. In some embodiments, if a second operation (for example, a click trigger) on the first control is detected, the terminal device 130 adjusts the playback progress of the first video by a predetermined amount. The terminal device 130 may fast forward the first video by a predetermined amount (e.g., 5 seconds, 10 seconds, or any other suitable predetermined amount) if a click trigger for the rightward control (i.e., the right key) is detected. The terminal device 130 may fast rewind the first video by a predetermined amount (e.g., 5 seconds, 10 seconds, or any other suitable predetermined amount) if a click trigger for the leftward control (i.e., the left key) is detected.

In some embodiments, the terminal device 130 may fast advancing or reversing the playback progress of the video based on clicking the first control by the user 132. The terminal device 130 may further fast advance or reverse the playback progress of the video based on the long-press of the first control by the user 132. However, these are merely illustrative, which is not limited in the disclosure. For example, the user 132 may further send an indication for adjusting the playback progress of the first video to the terminal device 130 in a manner of triggering by a voice, a gesture, or the like. Hereinafter, an adjustment instruction will be initiated mainly by user clicking or long-pressing the first control, and how to adjust the playback progress of the first video is described with reference to the drawings.

The following describes that the playback progress of the first video is adjusted by the terminal device 130 based on a first operation performed by the user 132 on the first control (for example, clicking a left key or a right key).

In some embodiments, if the second operation on the rightward control is detected, the playback progress of the first video may be advanced by a third predetermined amount. In some embodiments, a single fast advancing of the playback progress may be triggered by a single click control in the progress control mode. As shown in the example interfaces 200B and 200E shown in FIGS. 2B and 2E, in the progress control mode, if it is detected that the user 132 clicks the rightward control (e.g., the right key), the terminal device 130 may advance the playing of the first video forward by a third predetermined amount (e.g., 5 seconds, 10 seconds, or any other suitable predetermined amount). For example, if it is detected that the user 132 clicks the right key once, the terminal device 130 may advance the progress bar from an A position 224 of FIG. 2B to a B position 251 of FIG. 2E, and a difference between these two positions corresponds to the third predetermined amount.

In some embodiments, if the second operation on the leftward control is detected, the terminal device 130 may reverse the playback progress of the first video by a fourth predetermined amount. In some embodiments, a single fast reversing of the playback progress may be triggered by a single-click control in the progress control mode. As shown in the example interfaces 200B and 200F shown in FIGS. 2B and 2F, in the progress control mode, if a control instruction sent by clicking the leftward control (for example, the left key) by the user 132, the terminal device 130 may reverse the playback progress of the first video by a fourth predetermined amount (for example, 5 seconds, 10 seconds, or any other suitable predetermined amount). For example, if it is detected that the user 132 clicks the left key once, the terminal device 130 may reverse the progress bar from the A position 224 of FIG. 2B to a C position 261 of FIG. 2F, and a difference between these two positions corresponds to the third predetermined amount. In some examples, the third predetermined amount and the fourth predetermined amount may be the same, or different, and may or may not be distinguished from the first predetermined amount and the second predetermined amount mentioned above.

In some embodiments, the terminal device 130 may determine the third predetermined amount or the fourth predetermined amount according to a total duration of the first video. In some embodiments, the terminal device 130 may adjust the playback progress of the first video at different advancing or reversing amplitudes based on different durations of different first videos. In some examples, the longer the total duration of the first video, the higher the advancing or reversing amplitude at which the playback progress of the first video may be adjusted. For example, if the total duration of the first video is relatively long (e.g., over 5 minutes), the third predetermined amount or the fourth predetermined amount may be 10 seconds. If the total duration of the first video is relatively short (e.g., less than 10 seconds), the third predetermined amount or the fourth predetermined amount may be 5 seconds. However, this is merely an example, which is not limited in the disclosure.

The following continues with reference to the drawings to describe that the terminal device 130 adjusts the playback progress of the first video at a speed based on the long-press trigger (for example, by long-pressing the right key, or long-pressing the left key) for the first control by the user 132.

In some embodiments, if the first operation on the rightward control is detected, the terminal device 130 may advance the playback progress of the first video at a first speed. In some embodiments, the playback progress may be advanced at a speed by a long-press control in the progress control mode. As shown in the example interfaces 200B and 200E shown in FIGS. 2B and 2E, in the progress control mode, if it is detected that the user 132 long presses the rightward control (for example, the right key), the terminal device 130 may advance the first video forward at the first speed. For example, if it is detected that the user 132 long presses the right key, the terminal device 130 may fast advance the playback progress of the first video at the first speed (for example, 3 times speed or any other suitable speed) from the A position 224 of the progress bar.

In some embodiments, if the first operation on the leftward control is detected, the terminal device 130 may reverse the playback progress of the first video at a second speed. In some embodiments, the playback progress may be reversed at a speed by long pressing a control in the progress control mode. As shown in the example interfaces 200B and 200F shown in FIGS. 2B and 2F, in the progress control mode, if it is detected that the user 132 long presses the leftward control (for example, the left key), the terminal device 130 may rewind the first video at the second speed. For example, if it is detected that the user 132 long presses the left key, the terminal device 130 may fast reverse the playback progress of the first video at the second speed (for example, 3 times speed or any other suitable speed) from the A position 224 of the progress bar. In some examples, the first speed and the second speed may be the same, or different.

In some embodiments, any of the first speed and the second speed may be determined in the following manner. If it is determined that a total duration of the first video exceeds a first duration threshold and is less than a second duration threshold, the terminal device 130 may maintain the first speed or the second speed as a first predetermined value during adjustment of the playback progress. In some examples, if it is determined that the total duration of the first video exceeds the first duration threshold (e.g., 10 seconds, or any other suitable duration) and is less than a second duration threshold (e.g., 5 minutes, or any other suitable duration), the first speed or the second speed may be maintained at the first predetermined value (e.g., 3 times speed or any other suitable speed) during adjustment of the playback progress. That is, the terminal device 130 may adjust the playback progress of the first video at 3 times speed when an adjustment instruction of advancing or reversing is detected. In this way, in the case that a total video length of the first video is relatively short, in the progress control mode, in response to the long-press trigger on the first control, the playback progress may always be adjusted at a fixed speed.

In some embodiments, in the case that the total duration of the first video exceeds the second duration threshold, if it is determined that the playback duration of the first video that has been advanced or reversed is less than the third duration threshold, the terminal device 130 may determine the first speed or the second speed as a second predetermined value. Correspondingly, if it is determined that the playback duration of the first video that has been advanced or reversed exceeds the third duration threshold, the terminal device 130 may change the first speed or the second speed into a third predetermined value. The third predetermined value is greater than the second predetermined value. In other words, in the case that the total video length of the first video is relatively long, in the progress control mode, if the user has adjusted the playback progress for a long time (for example, having advanced or reversed a certain amount of playback progress), an adjustment speed corresponding to the long-press trigger may be increased, so that the user may more quickly adjust the playback progress.

For example, in a scenario in which the total duration of the first video exceeds the second duration threshold (for example, 5 minutes, or any other suitable duration), if it is determined that the playback duration (for example, 3 minutes) of the first video that has been advanced or reversed is less than the third duration threshold (for example, 5 minutes), the terminal device 130 may fast advance or reverse the playback progress of the first video at a speed of the second predetermined value (for example, 3 times speed). Further, if it is determined that the playback duration (for example, 5.5 minutes) of the first video that has been currently advanced or reversed exceeds the third duration threshold (for example, 5 minutes), the terminal device 130 may increase a speed of the second predetermined value (for example, 3 times speed) to a speed of the third predetermined value (for example, 6 times speed). In some examples, the third predetermined value may be a multiple of the second predetermined value. For example, assuming that the total duration of the first video is 15 minutes, i.e., exceeds the second duration threshold (e.g., 5 minutes), and starts the long-press trigger for the right key from the 3rd minute until the playback progress is advanced to the 14th minute. In this case, during a period from the 3rd minute to the 8th minute, the playback progress of the first video may be adjusted at a speed of the second predetermined value (for example, 3 times speed), and during the 8th minute to the 14th minute, the playback progress of the first video may be continuously adjusted at a speed of the third predetermined value (for example, 6 times speed).

Alternatively, in some other embodiments, in the case that the total duration of the first video exceeds the second duration threshold, if it is determined that the played duration of the first video is less than the third duration threshold, the terminal device 130 may determine the first speed or the second speed as a second predetermined value. Correspondingly, if it is determined that the played duration of the first video exceeds the third duration threshold, the terminal device 130 may change the first speed or the second speed into a third predetermined value, wherein the third predetermined value is greater than the second predetermined value. In other words, in the case that the total video length of the first video is relatively long, in the progress control mode, if it is determined that the played duration of the video exceeds a certain length, the adjustment speed corresponding to the long-press trigger may be increased, so that the user may more quickly adjust the playback progress.

In some examples, in a scenario in which the total duration of the first video exceeds the second duration threshold (for example, 5 minutes, or any other suitable duration), if it is determined that the played duration (for example, 4 minutes) of the first video is less than the third duration threshold (for example, 5 minutes), the terminal device 130 may adjust the playback progress of the first video at a speed of the second predetermined value (for example, 3 times speed). Further, if it is determined that the duration (for example, 5.5 minutes) of the first video that has been currently played exceeds the third duration threshold (for example, 5 minutes), the terminal device 130 may change a speed of the second predetermined value (e.g., 3 times speed) into a speed of the third predetermined value (for example, 6 times speed). In some examples, the third predetermined value may be a multiple of the second predetermined value.

In some embodiments, in the scenario in which a total duration of the first video exceeds a first duration threshold (for example, 10 seconds), if the first operation on the first control is detected, the terminal device 130 may adjust the playback progress of the first video at a speed, and if the second operation on the first control is detected, the terminal device 130 may adjust the playback progress of the first video by a predetermined amount. For example, in a scenario in which the total duration of the first video exceeds the first duration threshold (for example, 10 seconds), if the long-press trigger on the right key is detected, the terminal device 130 may fast advance the playback progress of the first video at a first speed. If the long-press trigger on the left key is detected, the terminal device 130 may fast reverse the playback progress of the first video at a second speed. If a click operation on the right key or the left key is detected, the playback progress of the first video may be advanced or reversed by a predetermined amount. That is, in the case that the total duration of the video is relatively long, the long-press trigger and the click trigger for the left key and the right key may be used to implement different adjustment manners for the fast forwarding or rewinding of the video.

Further, in the scenario in which the total duration of the first video is less than the first duration threshold (for example, 10 seconds), if at least one of the first operation or the second operation on the first control is detected, the terminal device 130 may adjust the playback progress of the first video by a predetermined amount. For example, if the long press trigger or click trigger for the right key is detected, the terminal device 130 may advance the first video by a third predetermined amount (e.g., 5 seconds, or any other suitable predetermined amount). If the long press trigger or click trigger for the left key is detected, the terminal device 130 may reverse the first video by a fourth predetermined amount (e.g., 5 seconds, or any other suitable predetermined amount). That is, in the case that the total duration of the video is relatively short, in the progress control mode, the playback progress is controlled to be adjusted by a predetermined amount regardless of whether the first control is long-pressed or clicked. This is because, in the case of a short video length, it may not be necessary to perform the speed adjustment as the adjustment at a speed may quickly advance the video to the end or reverse to a starting position.

In some embodiments, in the progress control mode, if it is determined that the remaining playback duration of the first video is less than or equal to a predetermined duration threshold, the terminal device 130 may cease advancing adjustment of the playback progress of the first video. At this time, even if the long press trigger or click trigger for the right key is detected in the progress control mode, advancing adjustment of the playback progress will no longer be continued. In some examples, in the progress control mode, if it is determined that the remaining play duration of the first video is less than or equal to the predetermined duration threshold (e.g., 3 seconds or any other suitable duration threshold), the terminal device 130 may cease the advancing. That is, for the scenario of advancing, the terminal device 130 may reserve the last part of video content, so that there may be still some playable content after ceasing the adjustment of the playback progress by the user.

In summary, according to different durations of different first videos, the playback progress of the video may be adjusted at different advancing or reversing amplitudes, so as to improve the user experience. For example, the longer the total duration of the video, the higher the advancing or reversing amplitude at which the playback progress of the video may be adjusted.

Some visual effects during adjustment of the first video playback progress are described below with continued reference to the accompanying drawings.

In some embodiments, in the process of advancing or reversing the playback progress of the first video, the terminal device 130 may present, in a first interface element corresponding to the first video, a visual effect associated with advancing or reversing. In some embodiments, the first interface element is configured to indicate playing and pausing of the first video.

In some examples, in the process of adjusting the playback progress of the first video to be advanced at the first speed, or in the process of adjusting the playback progress of the first video to be reversed a t the first speed, the terminal device 130 may present the first interface element in a visual effect associated with advancing or reversing. As shown in the example interface 200B shown in FIG. 2B, the terminal device 130 may present the first interface element in a form of a visual effect 225 in the process of adjusting the playback progress of the first video to be advanced at the first speed. The terminal device 130 may also present, in an interface 226, the first interface element in association with the first video and in a manner of the visual effect 225. In some examples, the visual effect 225 may be presented as a dynamic visual effect, such as the visual effect 225 being played circularly. A schematic diagram 200G of the visual effect of the interface element of the disclosure is described with reference to FIG. 2G. As shown in the example visual effect 200 GA shown in FIG. 2GA in FIG. 2G, if the playback progress of the first video is advanced at 3 times speed starting from a moment XX, the terminal device 130 may circularly play the first interface element 271 in the form of the visual effect 225 at the moment XX.

As shown in the example interface 200F shown in FIG. 2F, the terminal device 130 plays the first interface element in the form of the visual effect 262 in the process of adjusting the playback progress of the first video to be reversed at the second speed. The terminal device 130 may also present the first interface element in the interface 226 in association with the first video and in the manner of the visual effect 262. In some examples, the visual effect 262 may be presented as a dynamic visual effect, such as the visual effect 262 being played circularly. As shown in the example visual effect 200 GB shown in FIG. 2GB in FIG. 2G, if the playback progress of the first video is reversed at 3 times speed starting from a moment XX, the terminal device 130 may circularly play the first interface element 271 in the form of the visual effect 262 at the moment XX.

In some embodiments, in the process of adjusting the playback progress of the first video, the terminal device 130 may present a thumbnail of the first video at the adjusted playback progress. The terminal device 130 may present, in the process of adjusting the playback progress of the first video, the thumbnail of the first video at the playback progress in association with the playback progress of the progress bar. As shown in the example interfaces 200B and 200E shown in FIGS. 2B and 2E, in the process of advancing the playback progress of the first video at a speed, the terminal device 130 presents the thumbnail 227, a thumbnail 252, or the like in association with the playback progress of the progress bar. Thus, it is convenient for the user 132 to refer to which position it is currently advanced to. As shown in the example interfaces 200B and 200F shown in FIGS. 2B and 2F, the terminal device 130, in the process of advancing the playback progress of the first video at a speed, presents the thumbnail 227, a thumbnail 263, or the like in association with the playback progress of the progress bar, and it is convenient for the user 132 to refer to which position it is currently advanced to.

Thus, entering the progress control mode based on the long-press trigger for the first control may adjust the playback progress of the media content without affecting the basic function of a directional control. How to exit the progress control mode is described below with reference to the drawings.

In some embodiments, if a confirmation indication id detected in the progress control mode, the terminal device 130 may play the first video from a current playback progress of the first video. As shown in the example interfaces 200E and 200H shown in FIGS. 2E and 2H, in the progress control mode, the terminal device 130 may continue to play subsequent content 281 of the first video from a B position 251 of the progress bar 220 if a confirmation instruction (e.g., the user 132 clicks a “OK key”) is detected at the B position 251. As shown in the example interfaces 200E and 200I shown in FIGS. 2E and 2I, in the progress control mode, the terminal device 130 may continue to play subsequent content 291 of the first video from a C position 251 of the progress bar 220 if the confirmation indication is detected at the C position 251. That is, the user 132 may click the “OK key” to exit the progress control mode. At this time, the terminal device 130 may also cancel the presentation of the progress bar 220.

In some embodiments, if a cancellation indication is detected in the progress control mode, the terminal device 130 plays the first video from a playback progress of the first video before the progress control mode is triggered. In some examples, if the cancellation indication is detected in the progress control mode, the terminal device 130 may play the first video from an original playback progress of the progress bar. The original playback progress indicates a playback progress of the first video before the progress control mode is triggered. In some embodiments, the cancellation indication in the progress control mode is triggered by the second operation on the second control. The second control may be different from the first control. In some examples, the second control includes an upward control (i.e., an upper key) or a downward control (i.e., a lower key). Of course, the control for canceling adjustment of the playback progress may also include any other suitable control. Referring to the example interfaces 200E and 200A shown in FIGS. 2E and 2A, in the progress control mode, the terminal device 130 may continue to play subsequent content 212 of the first video from the A position 224 if the trigger for the second control (e.g., an upper key, a lower key, a return key, etc. included in the attachment device 110) is detected at the B position 251 of the progress bar 220.

It may be understood that the A position 224 of the progress bar 220 is a starting position at which the user 132 long presses first control (for example, the left key or the right key). In some embodiments, in the progress control mode, if the trigger for the second control (for example, the upper key, the lower key, the return key, and the like included in the attachment device 110) is detected at the B position 251 of the progress bar 220, the terminal device 130 may continue to play the first video from the starting position of the first video. That is, the terminal device 130 may exit the progress control mode, and at this time, the terminal device 130 may cancel presentation of the progress bar 220.

In some embodiments, in the non-progress control mode for the first video, the second control may be used to switch the video. That is, in the non-progress control mode for the first video, if the second operation on the second control is detected, the terminal device 130 may switch from a first image of the first video to a second image of a second video. In some examples, in the non-progress control mode for the first video, if a click trigger for the upper key is detected, the terminal device 130 may switch from the current video (that is, the first video) to the previous video. Correspondingly, in the non-progress control mode for the first video, if a click trigger for the lower key is detected, the terminal device 130 may switch from the current video (that is, the first video) to the next video.

In summary, entering the progress control mode based on the long press trigger for the first control may adjust the playback progress of the video without affecting the basic function of a directional control, thereby improving the user experience. Further, entering the progress control mode enables the user to fcous on the adjustment of the playback progress.

FIG. 3 illustrates a flowchart of a process 300 for playback control according to some embodiments of the disclosure. The process 300 may be implemented at the terminal device 130. The process 300 is described below with reference to FIG. 1.

At block 310, the terminal device 130 presents a first image of the first video.

At block 320, the terminal device 130 triggers a progress control mode for the first video in response to detecting a first operation on a first control, wherein the first operation indicates triggering the first control continuously within a predetermined time period.

At block 330, the terminal device 130 adjusts a playback progress of the first video in response to detecting at least one of the first operation or a second operation on the first control in the progress control mode, wherein the second operation indicates a click trigger for the first control.

In some embodiments, the process 300 further includes: presenting a progress bar of the first video in response to the progress control mode being triggered, wherein in the progress control mode, the adjusted playback progress of the first video is presented on the progress bar.

In some embodiments, the process 300 further includes: in response to the progress control mode being triggered, advancing the playback progress of the first video by a first predetermined amount based on the first control including a rightward control, or reversing the playback progress of the first video by a second predetermined amount based on the first control including a leftward control; and wherein adjusting the playback progress of the first video includes: in the progress control mode, continuing to adjust the playback progress of the first video in response to detecting at least one of the first operation or the second operation on the first control, starting from the playback progress advanced by the first predetermined amount or reversed by the second predetermined amount.

In some embodiments, adjusting the playback progress of the first video includes: adjusting, in response to detecting the first operation on the first control, the playback progress of the first video at a speed; or adjusting, in response to detecting the second operation on the first control, the playback progress of the first video by a predetermined amount.

In some embodiments, adjusting the playback progress of the first video by the predetermined amount includes: advancing, in response to the first control including a rightward control and in response to detecting the second operation on the rightward control, the playback progress of the first video by a third predetermined amount; or reversing, in response to the first control including a leftward control and in response to detecting the second operation on the leftward control, the playback progress of the first video by a fourth predetermined amount.

In some embodiments, at least one of the third predetermined amount or the fourth predetermined amount is determined based on a total duration of the first video.

In some embodiments, adjusting the playback progress of the first video at the second speed includes: advancing, in response to the first control including a rightward control and in response to detecting the first operation on the rightward control, the playback progress of the first video at a first speed; or reversing, in response to the first control including a leftward control and in response to detecting the first operation on the leftward control, the playback progress of the first video at a second speed.

In some embodiments, the process 300 further includes: maintaining, in response to a total duration of the first video exceeding a first duration threshold and less than a second duration threshold, the first speed or the second speed as a first predetermined value during the adjusting of the playback progress; or in response to the total duration of the first video exceeding the second duration threshold, determining, in response to a playback duration of the first video that has been advanced or reversed being less than a third duration threshold, the first speed or the second speed as a second predetermined value, and changing, in response to the playback duration of the first video that has been advanced or reversed exceeding the third duration threshold, the first speed or the second speed into a third predetermined value, wherein the third predetermined value is greater than the second predetermined value.

In some embodiments, adjusting the playback progress of the first video includes: in response to a total duration of the first video exceeding a first duration threshold, adjusting, in response to detecting the first operation on the first control, the playback progress of the first video at a speed; or in response to the total duration of the first video being less than the first duration threshold, adjusting, in response to detecting at least one of the first operation or the second operation on the first control, the playback progress of the first video by a predetermined amount.

In some embodiments, the first control includes a rightward control or a leftward control, and the process 300 further includes: switching, in response to detecting the second operation on the first control, from a first interface element associated with the first video to a second interface element associated with the first video in a non-progress control mode for the first video.

In some embodiments, the process 300 further includes: ceasing, in response to a remaining playback duration of the first video being less than or equal to a predetermined duration threshold, advancing adjustment of the playback progress of the first video in the progress control mode.

In some embodiments, the process 300 further includes: presenting, in a first interface element corresponding to the first video, a visual effect associated with advancing or reversing of the playback progress of the first video in a process of adjusting the advaning or the reversing, wherein the first interface element is configured to indicate playing and pausing of the first video.

In some embodiments, the process 300 further includes: playing, in response to receiving a confirmation indication in the progress control mode, the first video from a current playback progress of the first video; or playing, in response to receiving a cancellation indication in the progress control mode. the first video from an original playback progress of the first video before the progress control mode is triggered.

In some embodiments, the cancellation indication in the progress control mode is triggered by the second operation on a second control, and the second control includes an upward control or a downward control.

In some embodiments, the process 300 further includes: switching, in response to detecting the second operation on the second control, from the first image of the first video to a second image of a second video in a non-progress control mode for the first video.

In some embodiments, the process 300 further includes: presenting a thumbnail of the first video at the adjusted playback progress during the adjusting of the playback progress of the first video.

In some embodiments, a plurality of interface elements for triggering interaction with the first video are presented while presenting the first image of the first video, the process 300 further includes: in the progress control mode, maintaining presentation of the plurality of interface elements in response to receiving a pause playback indication for the first video.

In some embodiments, the process 300 further includes: in a non-progress control mode for the first video, playing, in response to a total duration of the first video exceeding a fourth duration threshold, the first video with presenting a progress bar of the first video; and playing, in response to the total duration of the first video being less than the fourth duration threshold, the first video without presenting the progress bar.

In some embodiments, the process 300 further includes: in a non-progress control mode for the first video, playing the first video with presenting a progress bar of the first video in a first visual style; and presenting, in response to receiving a pause playback indication for the first video, the progress bar in a second visual style, the second visual style being different from the first visual style.

In some embodiments, the process 300 further includes: in a non-progress control mode for the first video, presenting, in response to receiving a pause playback indication for the first video, guidance information for guiding a user to trigger the progress control mode.

Embodiments of the disclosure also provide a corresponding apparatus for implementing the above method or process.

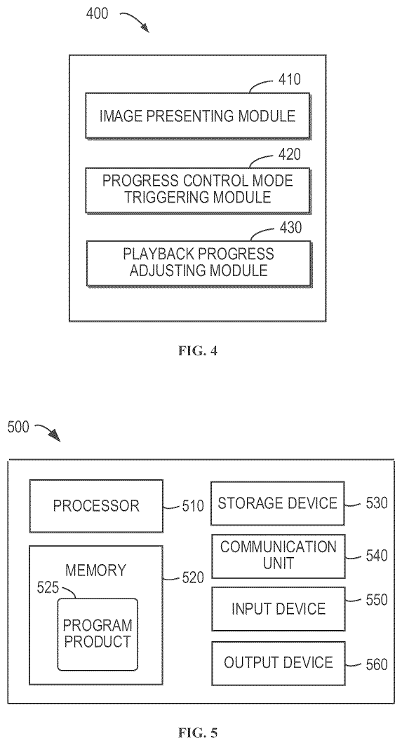

FIG. 4 illustrates a schematic structural block diagram of an apparatus 400 for playback control according to some embodiments of the disclosure. The apparatus 400 may be implemented or included in the terminal device 130. Various modules/components in the apparatus 400 may be implemented by hardware, software, firmware, or any combination thereof.

As shown in FIG. 4, the apparatus 400 includes an image presenting module 410 configured to present a first image of a first video. The apparatus 400 further includes a progress control mode triggering module 420 configured to trigger a progress control mode for the first video in response to detecting a first operation on a first control, wherein the first operation indicates triggering the first control continuously within a predetermined time period. The apparatus 400 further includes a playback progress adjusting module 430 configured to adjust a playback progress of the first video in response to detecting at least one of the first operation or the second operation on the first control in the progress control mode, wherein the second operation indicates a click trigger for the first control.

In some embodiments, the playback progress adjusting module 430 is further configured to present a progress bar of the first video in response to the progress control mode being triggered, and in the progress control mode, the adjusted playback progress of the first video is presented on the progress bar.

In some embodiments, the playback progress adjusting module 430 is further configured to, in response to the progress control mode being triggered, advance the playback progress of the first video by a first predetermined amount based on the first control including a rightward control, or reverse the playback progress of the first video by a second predetermined amount based on the first control including a leftward control; and wherein adjusting the playback progress of the first video includes: continuing to adjust the playback progress of the first video in response to detecting at least one of the first operation or the second operation on the first control, starting from the playback progress advanced by the first predetermined amount or reversed by the second predetermined amount in the progress control mode.

In some embodiments, the playback progress adjusting module 430 is further configured to adjust, in response to detecting the first operation on the first control, the playback progress of the first video at a speed; or adjust, in response to detecting the second operation on the first control, the playback progress of the first video by a predetermined amount.

In some embodiments, the playback progress adjusting module 430 is further configured to advance, in response to the first control including a rightward control and in response to detecting the second operation on the rightward control, the playback progress of the first video by a third predetermined amount; or reverse, in response to the first control including a leftward control and in response to detecting the second operation on the leftward control, the playback progress of the first video by a fourth predetermined amount.

In some embodiments, at least one of the third predetermined amount or the fourth predetermined amount is determined based on a total duration of the first video.

In some embodiments, the playback progress adjusting module 430 is further configured to advance, in response to the first control including a rightward control and in response to detecting the first operation on the rightward control, the playback progress of the first video at a first speed; or reversing, in response to the first control including a leftward control and in response to detecting the first operation on the leftward control, the playback progress of the first video at a second speed.

In some embodiments, the playback progress adjusting module 430 is further configured to maintain, in response to a total duration of the first video exceeding a first duration threshold and less than a second duration threshold, the first speed or the second speed as a first predetermined value during the adjusting the playback progress; or in response to the total duration of the first video exceeding the second duration threshold, determine, in response to a playback duration of the first video that has been advanced or reversed being lower than a third duration threshold, the first speed or the second speed as a second predetermined value, and change, in response to the playback duration of the first video that has been advanced or reversed exceeding the third duration threshold, the first speed or the second speed to a third predetermined value, wherein the third predetermined value is greater than the second predetermined value.

In some embodiments, the playback progress adjusting module 430 is further configured to, in response to a total duration of the first video exceeding a first duration threshold, advance the playback progress of the first video at a speed in response to detecting the first operation on the first control; or in response to the total duration of the first video being less than the first duration threshold, adjust the playback progress of the first video by a predetermined amount in response to detecting at least one of the first operation or the second operation on the first control.

In some embodiments, the first control includes a rightward control or a leftward control, and the apparatus 400 further includes an interface element switching module configured to switch, in response to detecting the second operation on the first control, from a first interface element associated with the first video to a second interface element associated with the first video in a non-progress control mode for the first video.

In some embodiments, the apparatus 400 further includes a ceasing adjusting module configured to cease, in response to a remaining playback duration of the first video being less than or equal to a predetermined duration threshold, advancing adjustment of the playback progress of the first video in the progress control mode.

In some embodiments, the apparatus 400 further includes a visual effect presenting module configured to present, in a first interface element corresponding to the first video, a visual effect associated with advancing or reversing of the playback progress of the first video in a process of adjusting the advaning or the reversing, wherein the first interface element is configured to indicate playing and pausing of the first video.

In some embodiments, the playback progress control module 430 is further configured to play in response to receiving a confirmation indication in the progress control mode, the first video from a current playback progress of the first video; or play, in response to receiving a cancellation indication in the progress control mode, the first video from an original playback progress of the first video before the progress control mode is triggered.

In some embodiments, the cancellation indication in the progress control mode is triggered by the second operation on a second control, and the second control includes an upward control or a downward control.

In some embodiments, the apparatus 400 further includes an image switching module configured to switch, in response to detecting the second operation on the second control, from the first image of the first video to a second image of a second video in a non-progress control mode for the first video.

In some embodiments, the apparatus 400 further includes a thumbnail presenting module configured to present a thumbnail of the first video at the adjusted playback progress, during the adjusting of the playback progress of the first video.

In some embodiments, a plurality of interface elements for triggering interaction with the first video are presented while presenting the first image of the first video, the apparatus 400 further includes an interface element presenting module configured to maintain presentation of the plurality of interface elements in response to receiving a pause playback instruction for the first video in the progress control mode.

In some embodiments, the apparatus 400 further includes a progress bar presenting module configured to, in a non-progress control mode for the first video, play the first video with presenting a progress bar of the first video in response to a total duration of the first video exceeding a fourth duration threshold; and play the first video without presenting the progress bar in response to the total duration of the first video being less than the fourth duration threshold.

In some embodiments, the progress bar presenting module is further configured to, in a non-progress control mode for the first video, play the first video with presenting a progress bar of the first video in a first visual style; and present, in response to receiving a pause playback indication for the first video, the progress bar in a second visual style, wherein the second visual style is different than the first visual style.

In some embodiments, the apparatus 400 further includes a guidance information presenting module configured to, in a non-progress control mode for the first video, present the guidance information for guiding a user to trigger the progress control mode in response to receiving a pause playback instruction for the first video.

The units and/or modules included in the apparatus 400 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 400 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), or the like.

It should be understood that one or more of the above methods may be performed by a suitable electronic device or a combination of electronic devices. Such an electronic device or a combination of electronic devices may include, for example, the terminal device 130 in FIG. 1.

FIG. 5 illustrates a block diagram of an electronic device 500 in which one or more embodiments of the disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the terminal device 130 in FIG. 1.

As shown in FIG. 5, the electronic device 500 is in the form of a general-purpose electronic device. Components of the electronic device 500 may include, but are not limited to, one or more processors 510 or processing units, a memory 520, a storage device 530, one or more communication units 540, one or more input devices 550, and one or more output devices 560. The processor 510 may be an actual or virtual processor and capable of performing various processes according to programs stored in the memory 520. In a multiprocessor system, a plurality of processors execute computer-executable instructions in parallel to improve the parallel processing capability of the electronic device 500.

The electronic device 500 generally includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), electrically erasable programmable read-only memory (EEPROM), a flash memory), or some combination thereof. The storage device 530 may be a removable or non-removable medium and may include a machine-readable medium, such as a flash drive, magnetic disk, or any other medium, which may be capable of storing information and/or data and may be accessed within the electronic device 500.

The electronic device 500 may further include additional removable/non-removable, volatile/ non-volatile storage media/medium. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 implements communication with other electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable a user to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the disclosure, there is provided a computer-readable storage medium having computer-executable instructions stored thereon, and the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processor of a general purpose computer, special purpose computer, or other programmable data processing apparatus to produce a machine, such that the instructions, when executed by a processor of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowchart and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for playback control, comprising:
presenting a first image of a first video;
triggering a progress control mode for the first video in response to detecting a first operation on a first control, wherein the first operation indicates triggering the first control continuously within a predetermined time period; and
adjusting a playback progress of the first video in response to detecting at least one of the first operation or a second operation on the first control in the progress control mode, wherein the second operation indicates a click trigger for the first control.

2. The method of claim 1, further comprising:
presenting a progress bar of the first video in response to the progress control mode being triggered,
wherein in the progress control mode, the adjusted playback progress of the first video is presented on the progress bar.

3. The method of claim 1, further comprising:
in response to the progress control mode being triggered,
advancing the playback progress of the first video by a first predetermined amount based on the first control comprising a rightward control, or
reversing the playback progress of the first video by a second predetermined amount based on the first control comprising a leftward control;
wherein adjusting the playback progress of the first video comprises:
continuing to adjust the playback progress of the first video in response to detecting at least one of the first operation or the second operation on the first control, starting from the playback progress advanced b y the first predetermined amount or reversed by the second predetermined amount in the progress control mode.

4. The method of claim 1, wherein adjusting the playback progress of the first video comprises at least one of the following:
adjusting, in response to detecting the first operation on the first control, the playback progress of the first video at a speed; or
adjusting, in response to detecting the second operation on the first control, the playback progress of the first video by a predetermined amount.

5. The method of claim 4, wherein adjusting the playback progress of the first video by the predetermined amount comprises:
advancing, in response to the first control comprising a rightward control and in response to detecting the second operation on the rightward control, the playback progress of the first video by a third predetermined amount; or
reversing, in response to the first control comprising a leftward control and in response to detecting the second operation on the leftward control, the playback progress of the first video by a fourth predetermined amount.

6. The method of claim 5, wherein at least one of the third predetermined amount or the fourth predetermined amount is determined based on a total duration of the first video.

7. The method of claim 4, wherein adjusting the playback progress of the first video at the speed comprises:
advancing, in response to the first control comprising a rightward control and in response to detecting the first operation on the rightward control, the playback progress of the first video at a first speed; or
reversing, in response to the first control comprising a leftward control and in response to detecting the first operation on the leftward control, the playback progress of the first video at a second speed.

8. The method of claim 7, further comprising:
maintaining, in response to a total duration of the first video exceeding a first duration threshold and less than a second duration threshold, the first speed or the second speed as a first predetermined value during the adjusting of the playback progress; or
in response to the total duration of the first video exceeding the second duration threshold,
determining, in response to a playback duration of the first video that has been advanced or reversed being less than a third duration threshold, the first speed or the second speed as a second predetermined value, and
changing, in response to the playback duration of the first video that has been advanced or reversed exceeding the third duration threshold, the first speed or the second speed into a third predetermined value, wherein the third predetermined value is greater than the second predetermined value.

9. The method of claim 1, wherein adjusting the playback progress of the first video comprises:
in response to a total duration of the first video exceeding a first duration threshold,
adjusting, in response to detecting the first operation on the first control, the playback progress of the first video at a speed; or
in response to the total duration of the first video being less than the first duration threshold,
adjusting, in response to detecting at least one of the first operation or the second operation on the first control, the playback progress of the first video by a predetermined amount.

10. The method of claim 1, wherein the first control comprises a rightward control or a leftward control, and the method further comprises:
switching, in response to detecting the second operation on the first control, from a first interface element associated with the first video to a second interface element associated with the first video in a non-progress control mode for the first video.

11. The method of claim 1, further comprising:
ceasing, in response to a remaining playback duration of the first video being less than or equal to a predetermined duration threshold, advancing adjustment of the playback progress of the first video in the progress control mode.

12. The method of claim 1, further comprising:
presenting, in a first interface element corresponding to the first video, a visual effect associated with advancing or reversing of the playback progress of the first video in a process of adjusting the advaning or the reversing,
wherein the first interface element is configured to indicate playing and pausing of the first video.

13. The method of claim 1, further comprising:
playing, in response to receiving a confirmation indication in the progress control mode, the first video from a current playback progress of the first video; or
playing, in response to receiving a cancellation indication in the progress control mode, the first video from an original playback progress of the first video before the progress control mode is triggered.

14. The method of claim 13, wherein the cancellation indication in the progress control mode is triggered by the second operation on a second control, and the second control comprises an upward control or a downward control.

15. The method of claim 1, further comprising:
presenting a thumbnail of the first video at the adjusted playback progress during the adjusting of the playback progress of the first video.

16. The method of claim 1, wherein a plurality of interface elements for triggering interaction with the first video are presented while presenting the first image of the first video, the method further comprising:
hiding the plurality of interface elements in the progress control mode; and
maintaining presentation of the plurality of interface elements in response to receiving a pause playback indication for the first video in a non-progress control mode for the first video.

17. The method of claim 1, further comprising:
in a non-progress control mode for the first video,
playing, in response to a total duration of the first video exceeding a fourth duration threshold, the first video with presenting a progress bar of the first video; and
playing, in response to the total duration of the first video being less than the fourth duration threshold, the first video without presenting the progress bar.

18. The method of claim 1, further comprising:
in a non-progress control mode for the first video,
playing the first video with presenting a progress bar of the first video in a first visual style; and
presenting, in response to receiving a pause playback indication for the first video, the progress bar in a second visual style, wherein the second visual style is different than the first visual style.

19. An electronic device, comprising:
at least one processor; and
at least one memory coupled to the at least one processor and storing instructions for execution by the at least one processor, the instructions, when executed by the at least one processor, causing the electronic device to perform operations comprising:
presenting a first image of a first video;
triggering a progress control mode for the first video in response to detecting a first operation on a first control, wherein the first operation indicates triggering the first control continuously within a predetermined time period; and
adjusting a playback progress of the first video in response to detecting at least one of the first operation or a second operation on the first control in the progress control mode, wherein the second operation indicates a click trigger for the first control.

20. A non-transitory computer-readable storage medium having stored thereon computer-executable instructions executable by at least one processor to perform operations comprising:
presenting a first image of a first video;
triggering a progress control mode for the first video in response to detecting a first operation on a first control, wherein the first operation indicates triggering the first control continuously within a predetermined time period; and
adjusting a playback progress of the first video in response to detecting at least one of the first operation or a second operation on the first control in the progress control mode, wherein the second operation indicates a click trigger for the first control.
